(19) United States
(12) Patent Application Publication
(10) Pub. No.: US 2007/0227206 A1
(43) Pub. Date: Oct. 4, 2007

(54) Lock box for fasteners

(76) Inventor: George W. Stone, Chicago, IL (US)

Correspondence Address: WELSH & KATZ, LTD, 120 S RIVERSIDE PLAZA, 22ND FLOOR, CHICAGO, IL, 60606, US

(21) Appl. No.: 11/728,923

(22) Filed: Mar. 27, 2007

Related U.S. Application Data
(60) Provisional application No. 60/786,682, filed on Mar. 28, 2006.

(51) Int. Cl. F16B 41/00

(52) U.S. Cl. 70/232

(57) ABSTRACT

In one form, a lock box for fasteners is provided that prevents unauthorized access to one or more fasteners. The lock box comprises a casing having at least one chamber within the casing and a rear wall and outward wall having at least one hole disposed on each wall large enough to accept a fastener. A drawer is also supplied having a device for securely engaging the casing when the drawer is inserted within the casing chamber preventing the drawer from being removed and restricting access to the one or more fasteners and fastener heads which the drawer covers. Other embodiments of the lock box may comprise a locking device which will enable for authorized access to the fasteners in the situation where an authorized user needs access to the fasteners to remove whatever device the fastener is securely holding in place.

### CROSS-REFERENCE TO RELATED APPLICATIONS

This application is related to U.S. Provisional Patent Application Ser. No. 60/786,682 filed Mar. 28, 2006 entitled “Seated Fastener Lock Box, for Male and Female Fasteners,” the entirety of which is incorporated as if set forth in its entirety herein.

### FIELD OF THE INVENTION

The invention is related to fasteners, particularly to a device rendering fastener heads inaccessible by preventing access to the fastener head, therefore preventing removal of the fastener.

### BACKGROUND OF THE INVENTION

Fastener locking devices of various types are well known in the art. Such devices and typically used to prevent unauthorized loosening or tightening of fasteners. For example, commercially available devices comprise tab or lock washers, safety wire, spring lock washers, keyed tab washers, Allen bolts, jam nuts, pins, and various other products.

However, previous fastener anti-tampering devices have some adherent disadvantages. One of the disadvantages with existing devices is that they cannot be used in combination and/or they are difficult to use. The present invention prevents or deters access to a fastener and fastener head and could be used in conjunction with existing devices if additional safety precautions are required. In one form, a lock box for fasteners may be used in conjunction with a public use bicycle rack whereby the rack is required to be securely mounted to a stationary device, such as for example, a parking meter pole, a wall, a sign pole, or any other stationary fixed mounting possibility. In this application, the fasteners used to mount the bicycle rack would be protected and unauthorized access denied by use of the lock box. The present device further requires less skill, less sophisticated tools and less time for a complete installation than existing fastener tampering devices.

In one form, the present device for a lock box provides an alternative to welding metal objects together with a greater assuredness that the fastener employed to fasten the objects is not accessible and therefore cannot be removed. In one embodiment, the lock box does not employ locking devices to the male shaft or female lug. The lock box could be used in conjunction with prior art devices for prevention of fastener tampering of any size, shape, and intended purpose and placed within the present lock box for added security.

### SUMMARY OF THE INVENTION

In one form, a lock box for fasteners is provided that prevents unauthorized access to one or more fasteners. The lock box comprises a casing having at least one chamber within the casing and a rear wall and outward wall having at least one hole disposed on each wall large enough to accept a fastener. A drawer is also supplied having a device for securely engaging the casing when the drawer is inserted within the casing chamber preventing the drawer from being removed and restricting access to the one or more fasteners and fastener heads which the drawer covers. Other embodiments of the lock box may comprise a locking device which will enable for authorized access to the fasteners in the situation where an authorized user needs access to the fasteners to remove whatever device the fastener is securely holding in place.

### BRIEF DESCRIPTION OF THE DRAWINGS

FIG. 1 is a perspective view of one embodiment of the casing and a drawer;

FIG. 2 is a perspective view of one embodiment of a drawer;

FIG. 3 is a left side view of one embodiment of a drawer;

FIG. 4 is a back side view of one embodiment of a drawer;

FIG. 5 is a perspective view showing one embodiment of a drawer and one embodiment of a casing with the casing front side removed;

FIG. 6 is a perspective view showing one embodiment of a drawer being inserted into one embodiment of a casing;

FIG. 7 is a perspective view showing one embodiment of a drawer inserted into a casing;

FIG. 8 is a perspective view showing one embodiment of a drawer inserted into a casing;

FIG. 9 is a side view showing one embodiment of a compression spring and pin;

FIG. 10 is a front view showing one embodiment of a compression spring and pin;

FIG. 11 is a perspective view of an alternate embodiment of a drawer;

FIG. 12 is a perspective partial cutaway view of the drawer of FIG. 11 showing the spring in compressed cycle;

FIG. 13 is a perspective partial cutaway view of the drawer of FIG. 11 showing the spring in uncompressed cycle;

FIG. 14 is a side view of the spring;

FIG. 15 is a perspective view of a partial cutaway of one embodiment of a drawer and a casing;

FIG. 16 is a perspective view of a partial cutaway of one embodiment of a drawer and casing showing the drawer fully inserted into the casing;

FIG. 17 is a side view of an alternate embodiment of a drawer inserted into a casing where the drawer has a cam lock and key arrangement;

FIG. 18 is a side view of the drawer of FIG. 17; and

FIG. 19 is a side view of one embodiment of the cam lock with a key.

### DETAILED DESCRIPTION

While the present invention is susceptible of embodiments in various forms, there is shown in the drawings and will hereinafter be described some exemplary and non-limiting embodiments, with the understanding that the present disclosure is to be considered an exemplification for the invention and is not intended to limit the invention to the specific embodiments illustrated. In this disclosure, the use of the disjunctive is intended to include the conjunctive. The use of the definite article or indefinite article is not intended to indicate cardinality. In particular, a reference to “the” object or “a” object is intended to denote also one of a possible plurality of such objects.

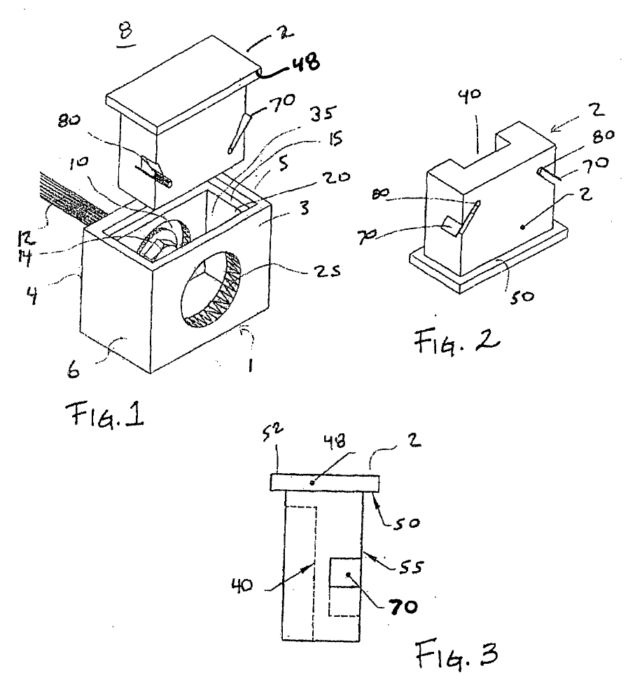

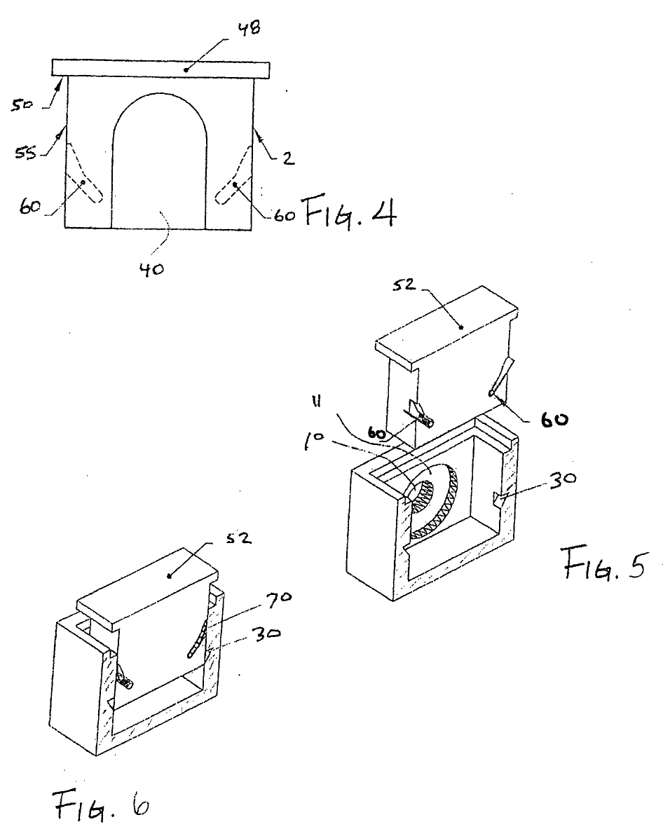

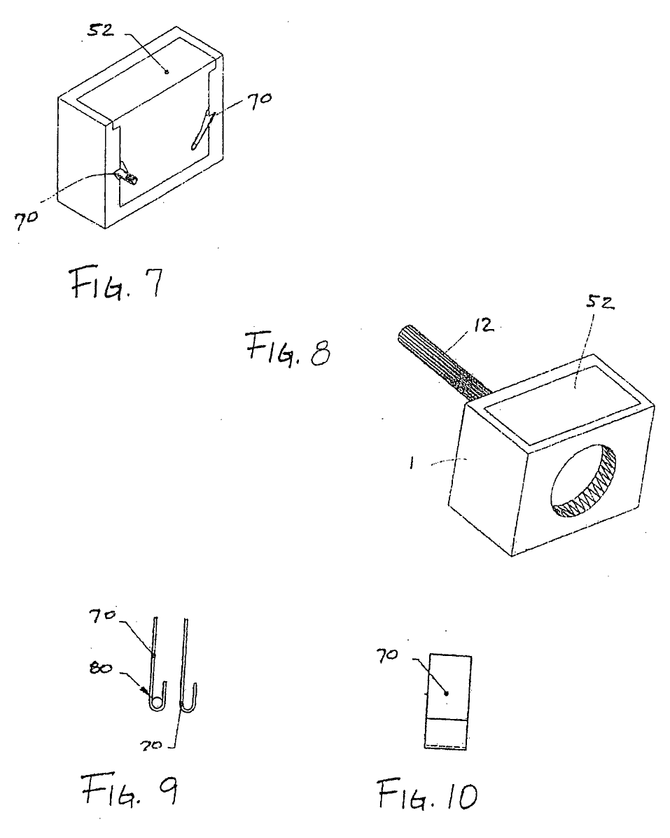

FIG. 1 is a perspective view of one embodiment of the lock box 8. In FIG. 1, in one form, a seated fastener lock box 8, for male and female fasteners, comprises an assembly of a casing 1 and a drawer 2. Both casing 1 and/or drawer 2 are shown in FIGS. 1-7.

In one embodiment, casing 1 comprises an outward face 3, a rear face 4, a right side 5 and a left side 6. Rear face 4 has a recessed seat 11 with one or more holes 10 and outward face 3 has one or more holes 25. A drawer chamber 35 is formed within casing I and a push plate seat 15 is positioned at the top portion of casing 1 substantially as shown in FIGS. 1, 5 and 6.

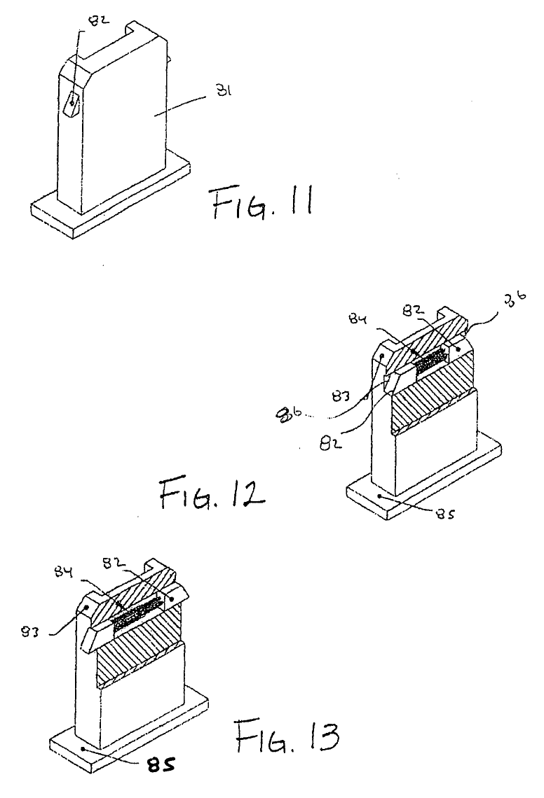

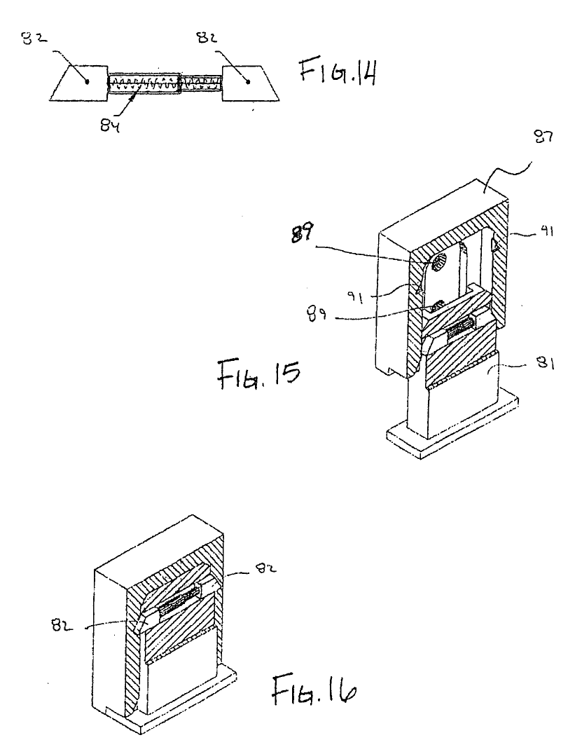

Casing I allows for a fastener 12 to pass through hole 25 and through hole 10. As shown in FIGS. 1-7, one embodiment of drawer 2 comprises a push plate 48, and drawer glides 55 on both left and right sides. The lower surface of push plate 48 is the push plate underside 50 surface. The compression spring cutouts 60 are placed on each right and left side of the drawer glide 55 surfaces. The push plate seat 15 enables the drawer 2 to rest upon 15 when the drawer has been fully seated. To properly guide the drawer 2 into the casing 1 the casing chamber walls 20 are on the sides of the casing chamber. Dual compression spring catch notches 30 are positioned in order to engage with the dual compression springs 70, on the drawer 2. FIG. 6 illustrates in one embodiment an opening 40 to the drawer chamber 35.

As shown in FIGS. 17-19, in other forms, the drawer 2 may contain a cam lock 95 and key 96 for enabling the removal of the drawer from the casing. In most forms, without the lock and key the inserted drawer 2 is considered non-removable or permanent. 100291 As shown in FIGS. 17-19, in one embodiment, lock and key arrangement will permit portability of, for example, a bicycle rack, as seasons change from summer to winter. It will also allow for whatever other device the lock box is used in connection with to be moved to various locations, for example, from yard to garage or during a special event such as a parade. In one embodiment, the cam lock and key arrangement comprise a spring actuated cam 97, a drawer push plate, a drawer, a cam notch 98 located in the casing. The cam notch 98 receives the spring actuated cam 97 thereby locking the drawer within the casing. Further, the cam lock and key arrangement may comprise a fastener and/or tool opening, and a push plate surface which is recessed for accepting the head of the cylinder of the threaded cam lock and key thereby deterring its removal. In use, as the key is rotated the cam 97 is pulled back into the cylinder enabling the removal of the drawer and the key then becomes a type of a doorknob or lever enabling the sliding of the drawer out of the housing. In the other forms, there are a variety of different cam lock styles available that may be selected for accomplishing the locking of the drawer within the housing. In this embodiment, compression spring 70 and pin 60 are not used.

FIGS. 9 and 10 depict one embodiment of the compression spring 70 and the compression spring lock pin 80. In one form, the compression spring 70 is sheet metal material able to be fulcrum forced about the compression spring lock pin 80. The compression spring 70 is held in the compression spring cutout 60 with the compression spring lock pin 80 in position as shown. Any of the embodiments and components herein described can be constructed of a variety of different materials, for example, metal, plastic, etc.

### Operation

To use the fastener lock box 8 for male and female fasteners a user first aligns one or more fasteners 12 through hole 25 and then through hole 10. A washer may also be used as shown in FIG. 1. A tool may be used to tighten the fastener whereby the tool may pass through hole 25. The tool easily passes through hole 25 and holds the fastener head, the bolt is turned into the female fastener member, as the bolt and washer is fully seated to the washer well and female fastener. In one application, the tool may be a power tool socket or type of hand tool required for the specific fastener and application. After the fastener realizes an appropriate torque setting the tool is removed. The casing rear face 4 is now seated securely against the female receiving member and casing 1 is securely held in place.

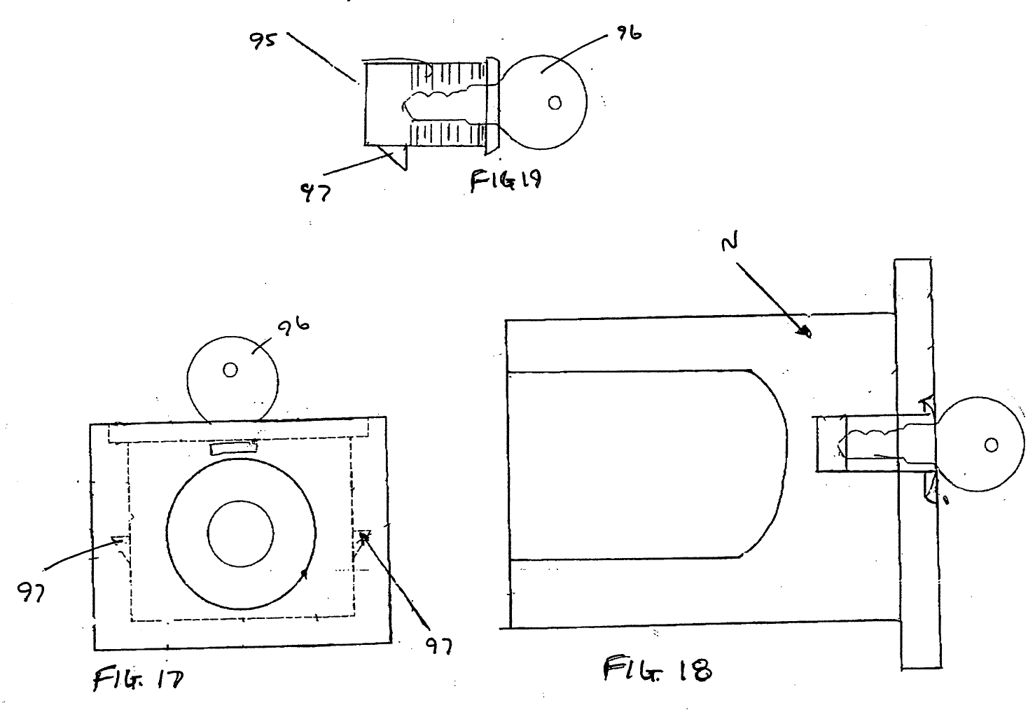

Now, drawer 2 is prepared to be inserted into casing 1. Preparation is done by insuring the opening 40 is facing the just inserted faster head 14. Taking drawer 2 in hand, preferably by push plate 48, a user begins to insert drawer 2 into the drawer chamber 35. As drawer 2 glides along casing walls 20 and drawer 2 is further inserted within the drawer chamber 35 the two compression springs 70 are compressed by the mating of walls of the drawer 2 and casing 1 pushing against each other. Simultaneously, the casing opening 40 glides over the seated fastener and the casing outward face 3 blocks access to fastener head 14 by covering hole 25. As the compression springs 70 reach each compression spring catch 30, the compression spring 70 decompresses and snaps into the respective compression spring catch 30. The drawer push plate 48 is then seated within the push plate seat 15 with the push plate underside 50 resting upon the push plate seat 15 as best shown in FIGS. 7 and 8. With the drawer 2 fully seated the fastener head is inaccessible and irremovable. In one embodiment, the drawer is unlockable, meaning once the drawer is placed within the chamber and fully seated and engaged, it is in essence non-removable. 100331 In yet other embodiments, as shown in FIGS. 11-16, other mechanisms may be used to secure different embodiments of the drawer within the casing. FIGS. 11-16 show another embodiment of a drawer 81 which comprises, in one form, one or more cams 82 operably connected to one or more springs 84 and whereby the drawer 81 has a recessed portion 86 for accepting and movably holding spring 84 and cam 82 in position within the drawer 81. In one embodiment, drawer 81 may have angled corners 83 as shown in FIGS. 12 and 13 to allow for easier insertion of the drawer into the casing. As best shown in FIG. 15, casing 87 may have one or more holes 89 to accept a variety of different fasteners. During use, as shown in FIGS. 15 and 16, drawer 81 may be positioned to align an insert within casing 87 and whereby cams 82 mate with the inside walls of casing 87 whereby the drawer is pushed into the interior chamber of casing 87 until cams 82 meet and align with catches 91. Then, catches 91 accept cams 82 and lock drawer 81 in position within casing 87.

Specific embodiments of novel methods and apparatus for construction of novel fastener lock boxes according to the present invention have been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention any and all modifications, variations, or equivalents that fall within the true spirit and scope of the basic underlying principles disclosed and claimed herein.

1. A lock box for preventing unauthorized access to one or more fasteners, said lock box comprising:
a casing having an outward wall, a rear wall, a left wall, a right wall, and at least one chamber;
the rear wall and outward wall having at least one hole disposed on each wall;
at least one catch disposed on at least one wall; and
a drawer having a means for securely engaging the at least one catch and whereby the drawer fits into the at least one chamber.

2. The lock box of claim 1 wherein the means for securely engaging comprises at least one compression spring and at least one securing pin positioned within the compression spring.

3. The lock box of claim 2 comprising the drawer having at least one compression spring cutout whereby the at least one compression spring and the securing pin fit within the at least one cutout.

4. The lock box of claim 1 wherein the drawer has at least one opening disposed on at least one side of the drawer.

5. The lock box of claim 1 wherein the drawer has at least one push plate positioned on one side of the drawer and a push plate underside which forms a lip.

6. The lock box of claim 1 wherein the casing has a push plate seat positioned adjacent the top of the casing.

7. The lock box of claim 1 wherein the rear wall hole can accept at least one fastener whereby at least one portion of the fastener remains within the casing chamber and at least one portion of the fastener extends outside of the casing chamber.

8. The lock box of claim 1 further comprising a key activated cam lock whereby the cam lock activates the means for securely engaging.

9. A lock box for preventing unauthorized access to one or more fasteners, said lock box comprising:
a casing having a chamber, an outward wall, a rear wall and two side walls;
the rear wall and outward wall having at least one hole disposed on each wall;
at least one means for securing disposed on the casing within the chamber; and
a drawer having a means for engaging the means for securing and whereby the drawer fits into the chamber and the means for engaging mates with the means for securing whereby the drawer cannot be removed from the casing.

10. The lock box of claim 9 wherein the means for securely engaging comprises at least one compression spring and at least one securing pin positioned within the compression spring.

11. The lock box of claim 9 comprising the drawer having at least one compression spring cutout whereby the at least one compression spring and the securing pin fit within the at least one cutout.

12. The lock box of claim 8 further comprising a key activated cam lock whereby the cam lock activates the means for engaging.

13. The lock box of claim 9 wherein the drawer has at least one opening disposed on at least one side of the drawer.

14. The lock box of claim 9 wherein the drawer has at least one push plate positioned on one side of the drawer and a push plate underside which forms a lip.

15. The lock box of claim 9 wherein the casing has a push plate seat positioned adjacent the top of the casing.

16. The lock box of claim 9 wherein the rear wall hole can accept at least one fastener whereby at least one portion of the fastener remains within the casing chamber and at least one portion of the fastener extends outside of the casing chamber.

17. A lock box for preventing unauthorized access to one or more fasteners, said lock box comprising:
a casing having a chamber, an outward wall, an rear wall, and two side walls;
the rear wall and outward wall having at least one hole disposed on each wall;
at least one catch disposed one the casing within the chamber; and
a drawer having a means for engaging the at least one catch and whereby the drawer fits into the chamber and the means for engaging mates with the catch; and
whereby the drawer has a means for unlocking whereby the drawer can only be removed from the casing when the means for unlocking is activated.

18. The lock box of claim 17 wherein the drawer has at least one opening disposed on at least one side of the drawer.

19. The lock box of claim 17 wherein the rear wall hole can accept at least one fastener whereby at least one portion of the fastener remains within the casing chamber and at least one portion of the fastener extends outside of the casing chamber.

20. The lock box of claim 17 wherein the means for unlocking is a lock.
